(19) United States
(12) Patent Application Publication
(10) Pub. No.: US 2004/0242309 A1
(43) Pub. Date: Dec. 2, 2004

(54) Lottery transaction device, system and method

(76) Inventors: Robert S. Melesko, Westerly, RI (US); James R. Breindel, Coventry, RI (US); Richard S. Meehan, South Kingston, RI (US); Robert Corvese, Warwick, RI (US); Timothy J. Mallin, Cranston, RI (US); Charles A. Rafuse JR., Westerly, RI (US); Raymond Alexandre, West Warwick, RI (US); Frank Metayer, Stonington, CT (US)

Correspondence Address: Thomas F. Bergert, Williams Mullen, PC, Suite 700, 8270 Greensboro Drive, McLean, VA, 22102, US

(21) Appl. No.: 10/801,098

(22) Filed: Mar. 15, 2004

Related U.S. Application Data
(60) Provisional application No. 60/454,530, filed on Mar. 13, 2003.

(51) Int. Cl. A63F 13/00

(52) U.S. Cl. 463/18

(57) ABSTRACT

A lottery device, system and method incorporates lottery and non-lottery transaction capabilities within a single, network-connected device, whereby the device communicates lottery transaction information to a central lottery server, while separately managing non-lottery transaction information. The system of the present invention provides a lottery network within which one or more devices of the invention can operate. The lottery network includes a back-end transaction processor and an interface for introducing new game types into the lottery system. In this way, a lottery distributor can not only offer a range of games that changes over time, but the distributor can choose which games to offer from an ever-changing menu of game options over a variety of device types.

### CROSS-REFERENCE TO RELATED APPLICATIONS

This application claims the benefit of U.S. Serial No. 60/454,530, filed Mar. 13, 2003 and entitled “Lottery Inside System”.

### TECHNICAL FIELD

The present invention relates to lottery systems, and more particularly to a system, method and device for selling lottery tickets using point-of-sale (POS) and other non-lottery terminals.

### BACKGROUND ART

Lottery systems are known whereby the public can purchase lottery tickets for the chance to win prizes. Tickets can take the form of instant tickets where the winning or losing status of the ticket can be determined immediately, or draw or online tickets, where the winning or losing status is only known after a specified event such as a drawing, for example. In such lottery systems, customers can purchase tickets at a dedicated lottery terminal in a convenience store or similar establishment. Each dedicated lottery terminal communicates with a central lottery server to exchange information and instructions associated with a given lottery transaction.

In the draw lottery ticket example, users can select one or more numbers actively or have the central lottery server randomly select numbers for them in what is sometimes referred to as a “quick pick” transaction. The dedicated terminal sends selected numbers to the central server to be stored and then receives directions from the central server to print the associated lottery ticket locally for the consumer. The lottery ticket can contain a barcode, serial number or other identifying feature unique to the ticket for validation and fraud prevention purposes.

In the typical lottery ticket distribution arrangement, convenience stores, liquor stores, grocery and drug stores, among others, act as agents for the lottery system provider, which is usually a governmental body. In such stores, lottery kiosks or terminals are typically physically separated from the main point-of-sale (POS) area where merchandise sales are transacted. Such separation facilitates check-out line movement and the separation of respective merchandise and lottery transactions for accounting purposes.

Despite the revenue and increased foot traffic received, lottery distributors are finding that they often cannot support the floor or counter space requirements for dedicated lottery terminals. They also find it more difficult to train staff on multiple machines, or to satisfy customers who wish to minimize check-out line waiting while being able to purchase both merchandise and lottery tickets together. Further, governments are finding it more difficult to fund and maintain dedicated lottery terminals, and feel they may be foregoing revenue opportunities because would-be lottery distributors do not have the physical and personnel resources to operate dedicated lottery terminals.

### DISCLOSURE OF INVENTION

The present invention, in part, solves the above problems by providing a lottery device, system and method which incorporates lottery and non-lottery transaction capabilities within a single, network-connected device, whereby the device communicates lottery transaction information to a central lottery server, while separately managing non-lottery transaction information. The system of the present invention provides a lottery network within which one or more devices of the invention can operate. The lottery network includes a back-end transaction processor and an interface for introducing new game types into the lottery system. In this way, a lottery distributor can not only offer a range of games that changes over time, but the distributor can choose which games to offer from an ever-changing menu of game options over different device types. The present invention also allows for the incorporation of phone card, gift card or other desirable retailer processing and delivery capabilities via the POS device.

The method of the present invention comprises: providing a POS device capable of conducting lottery and non-lottery transactions; providing a lottery transaction server operatively connected to the POS device, wherein the lottery transaction server can store and process lottery transaction information; and providing a lottery gaming server for offering various lottery games to be played and displayed on the POS device. In one embodiment, the method includes providing lottery and non-lottery software for enabling the POS device to conduct lottery and non-lottery transactions and select one or more lottery games for use. The POS devices include CPUs and monitors or displays to enable touch-screen or keyboard entry of menu selections in typically a browser-based environment.

In one embodiment of the invention, each POS device is also in communication with a POS server, which can filter lottery transaction information for the lottery server and can retain merchandise transaction information for local or regional processing depending on the business preferences of the lottery distributor.

### BRIEF DESCRIPTION OF THE DRAWINGS

FIG. 1 is a diagram showing one conceptual architectural layout of a sample implementation in connection with the present invention.

FIG. 2 is a diagram a sample architectural layout of the lottery network in connection with the system of the present invention.

FIGS. 3A through 3D are schematics of sample device layouts in accordance with several embodiments of the present invention.

FIG. 4 is a simplified block diagram of the lottery platform architecture layers in connection with one embodiment of the present invention.

FIG. 5 is a block diagram of the operational components of one embodiment of the present invention.

FIG. 6 is a diagram illustrating a sample implementation in accordance with a particular embodiment of the present invention.

FIG. 7 is a diagram illustrating a sample implementation of the present invention across multiple distributor types in accordance with one embodiment of the system of the present invention.

### MODE(S) FOR CARRYING OUT THE INVENTION

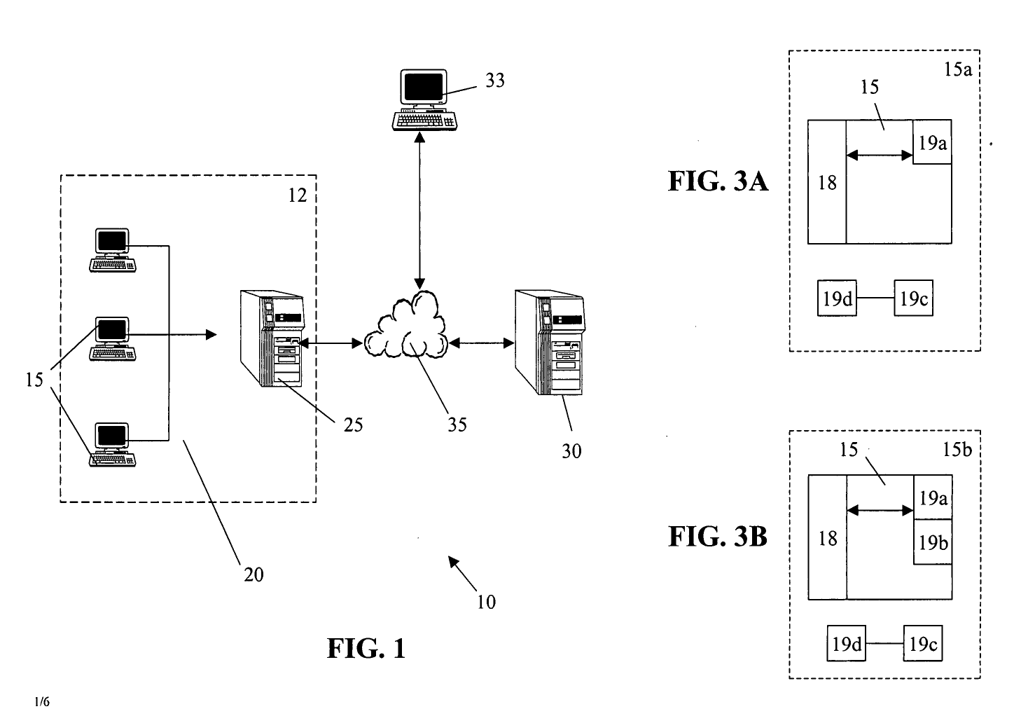

As shown in FIGS. 1 through 7, the lottery system 10 of the present invention can be used to enable various lottery service providers (e.g., state lotteries) to implement their lottery network and to enable distributors to better handle lottery transactions. In part, the present invention assists in the implementation of a platform for lottery system administration, lottery retailer or distributor transaction management, reporting, and integration and communication with lottery service providers and third party application developers.

As shown in FIG. 1, a plurality of POS terminals 15 such as might be found in a retail establishment 12 are operatively connected to a POS network 20, which can be a wireless or wired network operating using TCP/IP protocol, for example. The POS terminals can conduct lottery and non-lottery transactions. The POS network 20 can include a POS server 25 for managing information transfer pertaining to all transactions for accounting and reconciliation purposes. The POS server also filters or separates non-lottery transactions from lottery transactions, and forwards lottery-specific information to lottery backend system 30.

The POS server 25 is linked to a retail management system 33 and a lottery management system 30 via network 35 in accordance with one aspect of the present invention. Network 35 can be any of a number of network-types capable of data communications, including public switched data network (PSDN), integrated services digital network (ISDN), packet-switched network (e.g., TCP/IP), private data communication network, wireless network or other suitable network. Retail management system 33 allows lottery distributor management personnel to view and account for transactions processed at the POS devices and is operable for all types of retail trade styles, including single store as well as multiple store trade styles, for example.

It will be understood that the POS server 25 and lottery management system 30 each include a CPU, database, RAM and ROM for processing and storage of data and programs. They further include respective communication ports for communicating with the POS devices, between each other, and with external devices such as a lottery printer or combined receipt and lottery ticket printer, as will be described hereinafter.

POS devices 15 are also provided with a CPU, database, ROM, RAM, and communications port. It will be appreciated that POS devices can be those operated behind a traditional retail counter as well as self-service kiosks and other devices not operated behind the retail counter. The POS device 15 includes a monitor or display screen for displaying information to the cashier or device operator. In some cases, as in self-service kiosks, the device operator can be the lottery player. Several display devices well-known in the art, including LCD, LED, flat screen, plasma, CRT and others can be incorporated into the display device of the present invention. The POS device is also adapted to receive input via several methods, including keyboard, touch-screens and touch-screen overlays, mouse, barcode scanners, buttons and similar input mechanisms. Transaction processor instructions are stored by the device database and read and executed by the POS device CPU to process the transaction types involved in the present invention. At least one printer can also be provided in communication with the POS device of the present invention, to allow purchased lottery tickets to be printed.

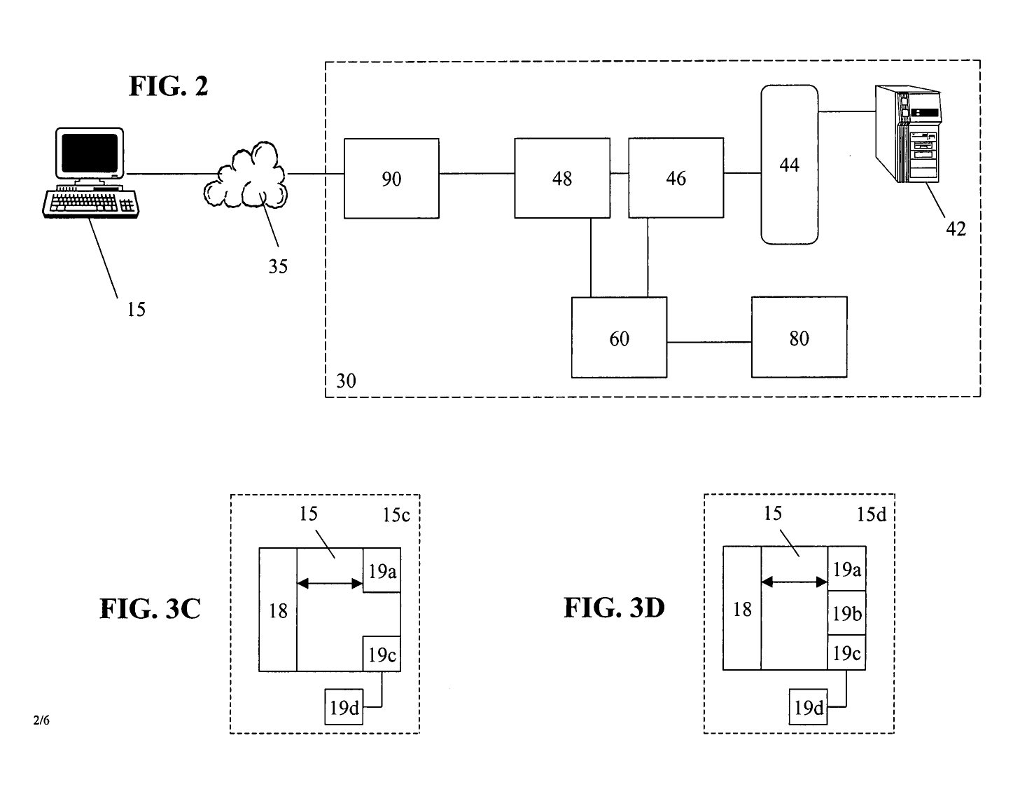

As shown in FIG. 2, the lottery POS device 15 of the present invention is integrated with the lottery management system 30 which can include a lottery engine or host component (indicated generally at 42), a message exchange component 44, a transaction processing component 46, an acquirer component 48, a commerce services component 60, a system services component 80, and a channel processing component 90. In one embodiment, the platform used in association with the present invention is based on the Model-View-Controller (MVC) architecture, known to those skilled in the art. MVC is the core architectural model for any Java 2 Enterprise Edition™ (J2EE) based system. The channel component 90 represents the “View”, the commerce services component 60 represents the “Model”, and the transaction processing component 46 represents the “Controller” of the system. In addition to serving lottery-integrated retailer point-of-sale (POS) devices as described herein, the present platform provides a common architecture and channel components for such other actors as Internet users/players, thick or thin client retailer POS devices, interactive televisions, and non-gaming transaction processors.

The POS devices 15 can be implemented using specific hardware as described, or using existing in-store POS devices and servers. For establishments with existing computerized POS devices in communication with an in-store or store-centralized POS server, the existing devices may be programmed to incorporate the system and functionality of the present invention. In one embodiment, such incorporation can involve ensuring a browser software program such as Microsoft Internet Explorer™ is capable of running on a software operating system such as Linux™ or Windows XP™, for example, so that the operator can view and execute programs stored either locally or in a centralized file server accessible via network 35.

The lottery sales agent POS devices or other lottery terminals can be “thin” client or “thick” client terminals. In a thin client implementation, a web browser such as Microsoft Internet Explorer™ resides on the POS device and accesses appropriate gaming applications available on the network from an application server (or combination web server and application server). When a transaction occurs, inputs from the thin client are transmitted to the application server where they are processed and transmitted to the lottery central system for logging. The serial number is then transferred back to the IP printer at the agent location, where the lottery ticket is printed. In a thick client implementation, a complete lottery application resides on the POS terminal and the data can be communicated throughout the network such as from the lottery terminal to the central system. It will be appreciated that the present invention can be used by current lottery service providers having an existing thin or thick client topology in place. It will further be appreciated that the present invention can accommodate a variety of input and output devices.

FIGS. 3A through 3D show example hardware and software implementations, 15a through 15d, associated with the POS device of the present invention. As shown in FIGS. 3A through 3D, third party software applications 18 or a standard Internet browser 19b can provide the user interface for lottery activities. In either case, the POS terminal 15 can additionally integrate a transaction handler 19a and a peripheral server 19c. The purpose of the transaction handler 19a is to abstract system communications and security details from the third party application 18, which is necessary to keep future updates or modifications to system communications and/or security isolated to one controllable component. To do this, the transaction handler 19a provides an interface that the third party application 18 must conform to. The interface defines how and what data will be exchanged with the transaction handler 19a. The transaction handler exchanges data with the retailer channel 90 in a defined format, as will be understood in the art. The transaction handler 19a, browser 19b and peripheral server 19c can all communicate with the retailer channel 90 shown in FIG. 2.

The transaction handler 19a can have different functionality depending upon the user interface used. In one embodiment, the transaction handler can provide methods for passing sales information only, while in another embodiment, methods for exchanging data for all lottery activities can be provided. The peripheral server 19c provides services to devices such as printer 19d. The peripheral server can be local to the printer and can be running in the device itself, in the POS or in a “black box” type of device separate from device 15, as shown in examples 15a and 15b in FIGS. 3A and 3B, respectively. The server can provide security and services for printing tickets, for example. The peripheral server 19c can communicate with devices 15 using a space serial (e.g., RS232) port and does not require any interaction with the third party application 18.

Device 15 can be designed with a browser interface that accesses the appropriate channel server when lottery functionality is desired. The channel server then provides the lottery user screens that are displayed on the POS device. In one embodiment, the POS device can be provided with touch screen input capabilities, allowing the retailer to perform the normal lottery sales transaction by touching areas on the screen. The lottery transaction is then processed through the IP network 35, channel server 90, acquirer 48 and the transaction processing engine 46. The transaction is processed and logged in the same secure manner, and then sent back through the secure system directly to the secure lottery printer where the ticket is presented to the retailer.

In one embodiment, the lottery management system and the lottery service provider processing components 30 include a series of PC servers which individually handle transaction processing, communications, data storage, game management and network management functions. For example, the transaction processing engine 46 processes, logs, and stores all transactions on a real-time basis. The transaction processing engine can communicate using Internet protocol (IP) over one or more secure local area networks (LANs) or wide area networks. In one embodiment, the communications servers can integrate the variety of communications networks (POTS, dial-up, frame relay, x.25, Internet) used by the lottery service provider and provide the interface to the lottery terminals.

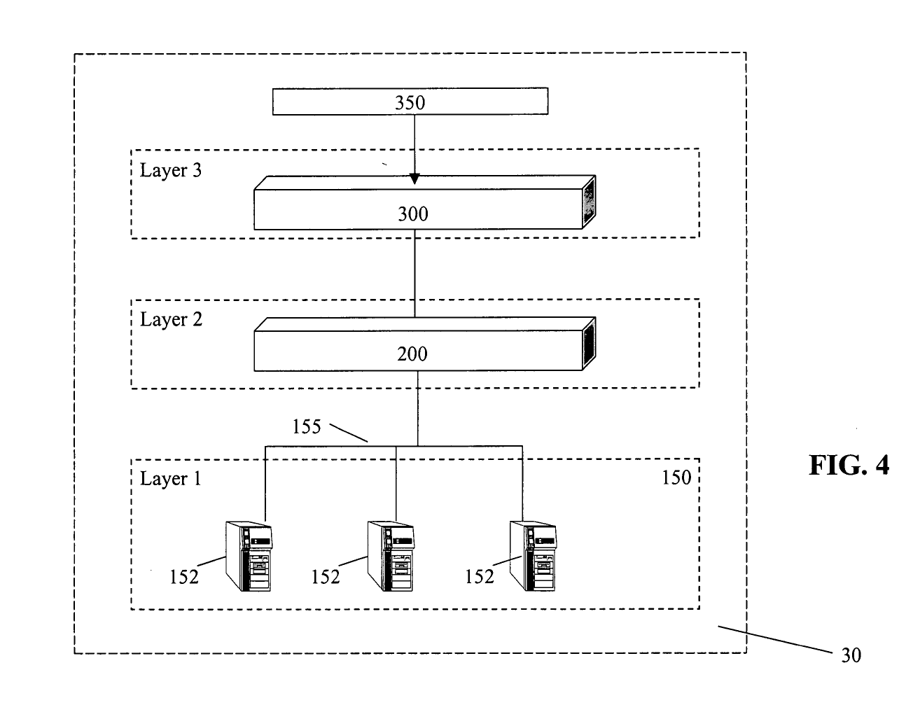

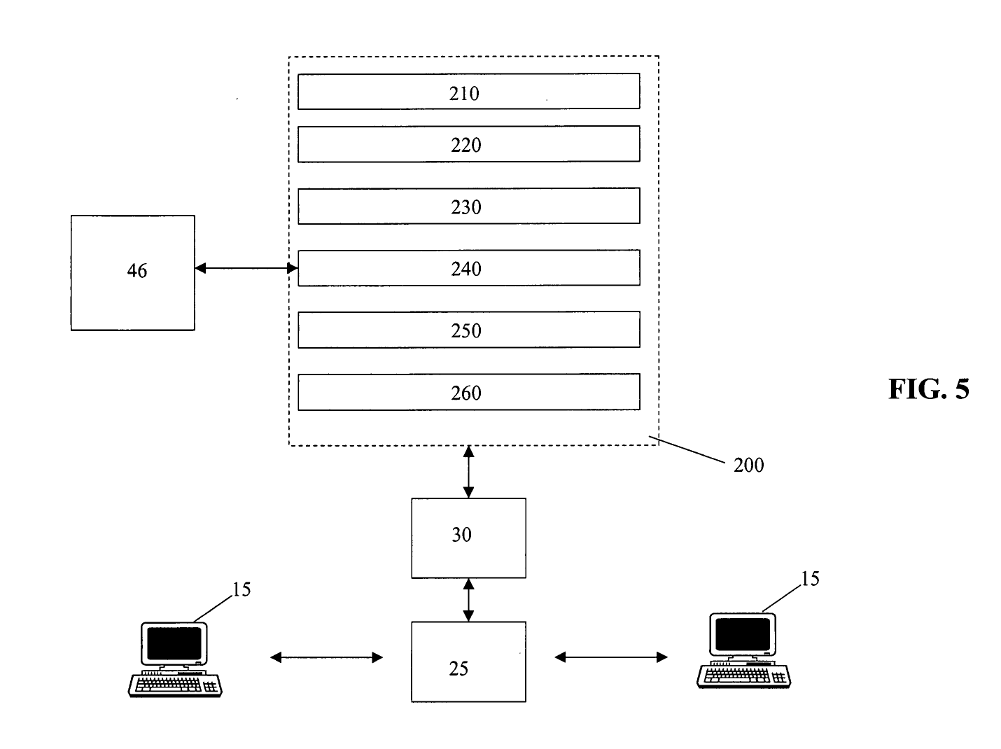

FIGS. 4 and 5 are diagrams illustrating an example specific lottery management and transaction processing system 30 for use in connection with the present invention. As shown in FIG. 4, this system 30 can be logically comprised of three separate software layers. The base layer 150 (Layer 1) is the system interface layer, which defines the communication and hardware functions and other system components. The base layer can comprise a network of servers 152 which facilitates communication between PC-based client terminals and a transaction processing engine. In one embodiment, the base or network layer can include a proprietary IP (Internet protocol) network 155. In an IP-based network, a server on the network logically and dynamically supplies POS device addresses. Data packets are routed/switched within the network based upon source and destination information contained within each packet. An IP network such as can be used in the present invention provides inherent flexibility in deploying client terminals and routing transactions throughout the network. Full redundancy of the network, advanced recovery mechanisms, and network operations and customer support services ensure the continuous network availability necessary for lottery service providers. In one embodiment of the invention, the core network can be a virtual private network (VPN).

At the base or network layer, security can be implemented in order to provide authentication, authorization, and integrity services for data carried on the network. Such security can assist in protecting the network and its users from network-based attacks, which may be conducted by outsiders attempting to read data, modify data, deny service such as by exhausting network resources, and probe network configurations. Such protection against external attacks can be provided, for example, by firewalls, IP filtering, IP tunneling, hub authentication and line encryption, as well as by the physical and logical protection of the associated servers and routers within the lottery sales agent and lottery service provider equipment.

As shown in FIGS. 4 and 5, the middle layer 200 (Layer 2) is the gaming platform services layer, which resides above the base or network layer. With a secure, reliable network in place, the present invention can securely transfer information for lottery service providers. The gaming platform services layer is the middleware layer that provides the most commonly needed middleware services for a lottery system. This includes the transaction processing engine 46 and can further include capabilities for network management 210, sales agent management 220, communication services 230, game management 240, reporting 250, security 260 and other management functions such as system administration, hotline application administration, point of sale administration, and retail management functionality. Gaming platform services 200 connect to the transaction processing engines over LANs or WANs and host all instant and online game validation, retailer management, accounting, instant ticket distribution management and reporting functions. This is the lottery service provider's direct interface into the lottery system. For the lottery service provider, gaming platform services can include adding and removing lottery sales agents, adding and removing game applications, adding and removing back-office business applications, restoring faulty network connections, and monitoring the security and efficiency of the lottery system. The lottery transaction processing engine can host traditional lottery applications and can process, log, and store lottery transactions from each lottery sales agent for the lottery service provider. In one embodiment of the present invention, the transaction processing engine can be a ProSys™ or AlphaGOLS™ transaction processing engine.

The middle layer for each lottery service provider can include a web server, an application server, a message exchange component and a lottery engine or transaction processing engine as described. The application server and web server can comprise a channel component 90 as described earlier. The message exchange component takes data delivered via Internet protocol and makes it interpretable by the lottery transaction engine component. The web server can act as an HTTP server, thereby serving as a conduit for devices (e.g., 15) containing browsers for accessing applications as provided by the present invention. The application server provides the applications for use with the present invention, including lottery game applications in the thin client embodiment of the present invention. Lottery game applications can alternatively be stored on a separate lottery server. In one embodiment of the invention, the application server functions are allocated across numerous application servers.

As described earlier, the application server is, in one embodiment, J2EE (Java 2 Enterprise Edition) compliant. Typically, the application server can interface with system databases in order to retrieve and store transaction information. The web servers and application servers can operate in a variety of operating systems, including Windows™, Linux™ or Unix™ operating systems, and can interface with various types of commercially available databases, including Sybase™, Oracle™, Informix™, IBM™ and Microsoft SQL™.

As further shown in FIG. 4, the top layer (Layer 3) is the application or gaming platform API layer 300. The top layer 300 provides the communication methods for accessing the gaming platform services layer. It is at this layer that third party developer applications 350 can communicate and be integrated with the system of the present invention.

At the lottery sales agent level, the system administration capabilities depend upon the sales agent and the types of lottery dispensing technologies employed. For example, a particular retailer may have stores in multiple locations and may desire to centrally manage the lottery operations of each store. As shown at 33 in FIG. 1, such a lottery sales agent can be provided with system and network management capabilities, reporting and interfaces for non-lottery third party applications.

Lottery sales agents can communicate directly with their particular state lottery via private network or over a public network such as the Internet. The communications between the state lottery service provider and the lottery sales agent generally pertain to the purchase and recordation of lottery drawing tickets. For example, a particular state lottery may offer instant scratch tickets as well as various types of lottery drawing games, including a Pick-3 game, a Pick-4 game, a Super Lotto game, and a multi-state game. For the lottery drawing games, it is necessary to record different fields of information to determine the ultimate cash prize distributions. Thus, the communication from a particular sales agent may include the purchaser's selected numbers, the store in which the purchase was made, the game related to the purchase, and the date and time of purchase. Once sent to the lottery service provider, this information is processed by the game's transaction processing engine and stored in a database, and information is sent back to the lottery sales agent for the printing of a lottery ticket receipt.

A channel (e.g., 90) is the interface to the lottery backend in connection with the present invention from a user-device access perspective. The channel operates based on the system actor, the device being used and the communication method. Upon receiving requests from the point of contact device, the channel identifies the type of request, validates the input, and routes the request to the appropriate acquirer. The channel is also responsible for managing user session data and will pass any errors back to the point of contact device.

The lottery engine or host 42 can comprise one or more different types of lottery hosts. Lottery hosts such as the AlphaGOLS™, EuroGOLS™ and ProSys™ systems are examples of hosts for use with the present invention. EuroGOLS™, AlphaGOLS™ and ProSys™ are commercially available from GTECH Corporation, West Greenwich, R.I., USA. EuroGOLS™ and AlphaGOLS™ hosts provide online and instant ticket processing functions, and ProSys™ provides video lottery processing functions for lottery games such as bingo, blackjack, poker and keno, for example.

The transaction processing engine 46 ensures the integrity of the system of the present invention by automating the transfer of data between the back-end lottery host and storage components and the front end point-of-contact devices. In part, the transaction engine can cache and asynchronously send requests when the host is unavailable, and can also cache responses. The transaction engine includes a series of acquirers 48 corresponding to a respective channel component 90. A transaction acquirer acquires transactions and processes them with a suitable processor 46. The acquirer is responsible for identifying the message request from the channel and forwarding the message to the appropriate processor. In one embodiment, the acquirer exists in the form of a command and is the placeholder for the business logic for authentication and coordination of game play. The command locates the correct game processor for the request and forwards the game option information to that processor. The acquirers can also pre-process some of the acquirer transactions, such as performing the management and accounting functions for the actors, for example. As shown in FIG. 2, the acquirers are in communication with the commerce services component 60, as well as transaction processor 46.

A transaction processor 46 manages and account for the products used in accordance with the present invention. The role of transaction processors is product management. In one embodiment of the present invention, the games use a transaction processor, which is the placeholder for the business logic for wagers, validations, and cancellations. The current generation of processors is lightweight and most of the transaction processing is done at an external host that is connected to the system of the present invention. These processors delegate their processing functions to external systems through message exchange. For example, lightweight processors can delegate their processing functions to external systems through message exchange component 44. In one embodiment, processors can include a sports processor, numbers processor, lotto processor, PowerBall processor and Instant game processor.

Message Exchange (MX) 44 provides the interface between the internal processing in accordance with the present invention and the external processing systems such as provided by hosts 42. MX can be based on an application programming interface/service provider interface (API/SPI) model. SPI is the programming interface for interfacing with the external processing systems. In one embodiment, a product routing code can direct the system to route the transaction to the transaction engine via Message Exchange (MX), for example, whereupon a timer can be set for transaction timeout while waiting on the transaction engine. Message Exchange (MX) is a communications protocol that enables the transaction engine to communicate with a lottery host. In one embodiment, the MX resides partially on the lottery host 42 and partially on the transaction engine 46. The MX can take data received via Internet protocol (IP) and makes it interpretable by the lottery host 42 and vice versa. The MX client/server architecture supports both push and pull message flow models, allowing both client and server systems to initiate message traffic and act as senders and receivers of messages. The client and server side processes implemented via MX are well-known in the art and do not necessitate detailed explanation.

System services component 80 can include a system database, e-mail server, Java naming and directory interface (JNDI) server, and business object repository, as well as other system services elements such as policy server and database management programming. The database tables used by the present invention can include the retailer profile, game parameters, and device profile, for example. Retailer profile can contain values for agent, teller, terminal number, wager units, validation units, and CDC date. Game parameters can contain values specific to each game and device profile contains information about the terminals connected to the system.

The commerce services 60 in connection with the lottery management system can provide for a claims and settlement system in connection with the acquiring processor or transaction engine. The claims and settlement system provides transaction settlement, auto-reconciliation, and claims management for retail operators and service providers. The system also performs adjustments processing, transaction fee processing, and balancing, monitoring and reporting functions, while further supporting multiple settlement entity types, such as institutions, interchanges, banks, merchants, operators and terminals. The commerce services component further provides for the management of user and device profiles, accounts, product catalogs, electronic wallet functionality and electronic fund transfer. Operation

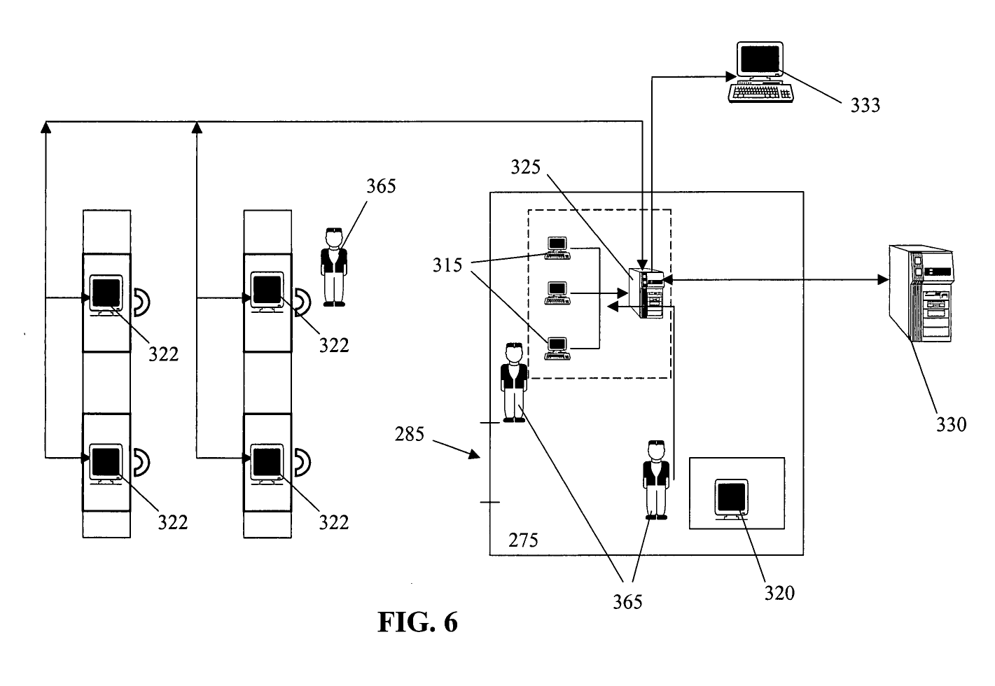

FIG. 6 is a diagram showing a sample implementation of one embodiment of the present invention. As shown therein, a commissioned lottery retailer 275 (shown with doorway 285) such as a gas station can have as part of its existing infrastructure a plurality of transaction devices including cashier POS devices 315, a self-service kiosk 320 such as convenience stores, and self-service gas pump credit processing centers 322. The existing infrastructure can be in the form of system hardware, software, network connectivity and related services. Devices 315, 320 and 322 are connected via network connection to retailer server 325, which can communicate with retailer manager system 333 and lottery system 330 as described above.

In one embodiment, the level of interaction permitted by a specific retailer can be determined by the lottery provider commissioning the specific retailer. Lottery or game players 365 can interact at any of devices 315, 320 or 322 to enjoy the game offerings, buy and print tickets and conduct non-lottery transactions, such as paying for gasoline, merchandise or other items available. In one embodiment, the lottery interface allows the users to track winnings, track account information and view other player information.

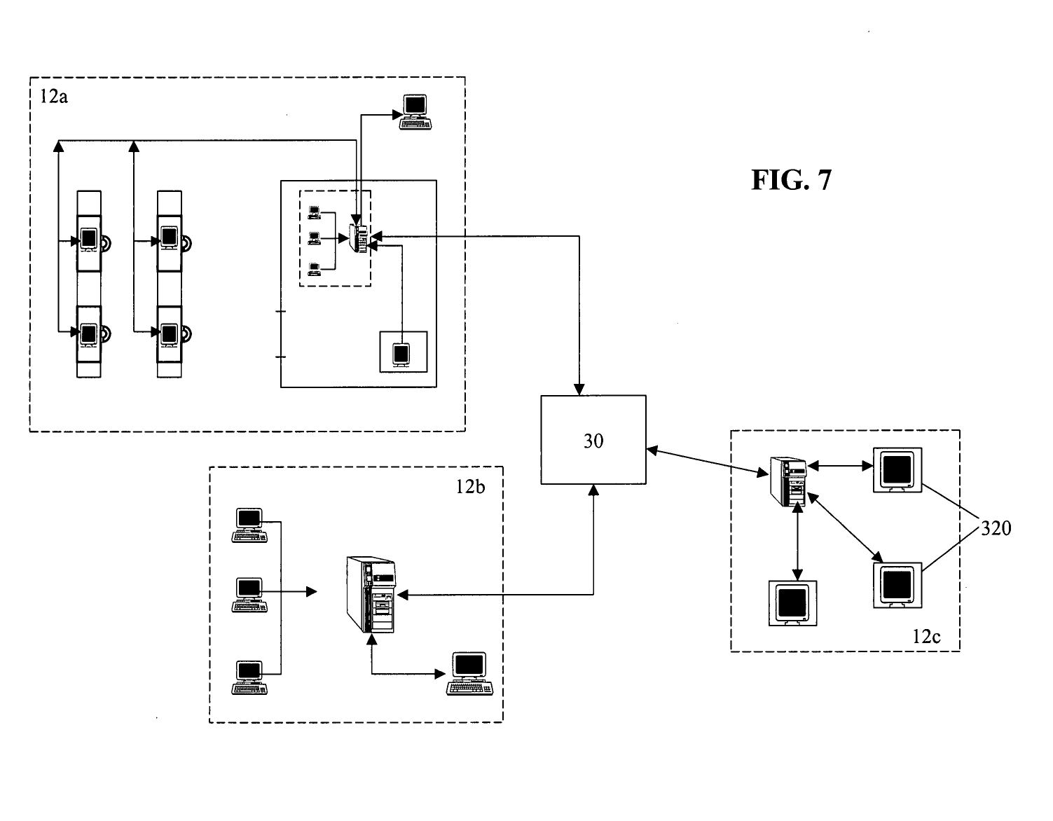

As shown in FIG. 7, the lottery backend system 30 can simultaneously serve multiple retailers and/or lottery distributors, including retailer 12a having multiple POS device-types (similar to gas station retailer 275 in FIG. 6), retailer 12b having multiple POS devices 15 in a single location (such as a supermarket, for example), and distributor 12c having a plurality of stand-alone kiosk devices 320 spread over a region, for example.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

What is claimed and desired to be secured by Letters Patent is:

1. A transaction processing device, comprising:
a POS terminal having a CPU and a display;
a lottery game controller in communication with said terminal;
a lottery transaction controller in communication with said terminal;
retailer software operable by said CPU for displaying an interface associated with at least one non-lottery-related retailer function on said terminal display; and
lottery software operable by said CPU for displaying an interface associated with at least one lottery-related retailer function on said terminal display.

2. The device of claim 1 wherein said terminal is provided with memory and said retailer software is stored in and operable from said memory for display on said display.

3. The device of claim 1 wherein said retailer software is stored on a retailer controller in communication with said terminal and operable by said CPU for display on said display.

4. The device of claim 1 wherein said terminal is provided with memory and said lottery software is stored in and operable from said memory for display on said display.

5. The device of claim 1 wherein said lottery software is stored on a lottery controller in communication with said terminal and operable by said CPU for display on said display.

6. The device of claim 1 wherein said lottery software is operable for managing lottery game offerings and wherein said interface is a game selection interface.

7. The device of claim 6 wherein said lottery game controller hosts a plurality of available lottery games and wherein said interface allows selection of a game offering hosted by said game controller and selected by a user of said POS terminal, said selection being communicated to said lottery game controller.

8. The device of claim 7 wherein said interface displays an interface associated with said selected game upon said selection being communicated to said game controller.

9. The device of claim 1 wherein said lottery software is operable for managing lottery transactions and wherein said displayed interface is taken from the group consisting of: lottery ticket purchase, lottery ticket cancellation, lottery ticket validation, lottery game result query.

10. The device of claim 9 wherein said lottery transaction controller facilitates processing of lottery transactions with a remote lottery host system.

11. The device of claim 9 wherein said display is a lottery ticket purchase display and wherein said display includes selection options for executing one of: a quick pick ticket, a draw ticket.

12. The device of claim 1 wherein said terminal further is in operating communication with a printing device.

13. The device of claim 1 wherein said interface is displayed via a web browser.

14. A method of conducting lottery transactions, comprising the steps of:
providing at least one POS device adapted for lottery and non-lottery transactions, said POS device being further provided with a CPU and a display;
providing a lottery game controller operatively connected to said at least one POS device;
providing a lottery transaction server operatively connected to said at least one POS device;
providing retailer software operable by said CPU for displaying an interface associated with at least one non-lottery-related retailer function on said terminal display; and
providing lottery software operable by said CPU for displaying an interface associated with at least one lottery-related retailer function on said terminal display.

15. The method of claim 14 wherein said terminal is provided with memory and said retailer software is stored in and operable from said memory for display on said display.

16. The method of claim 14 wherein said retailer software is stored on a retailer controller in communication with said terminal and operable by said CPU for display on said display.

17. The method of claim 14 wherein said terminal is provided with memory and said lottery software is stored in and operable from said memory for display on said display.

18. The method of claim 14 wherein said lottery software is stored on a lottery controller in communication with said terminal and operable by said CPU for display on said display.

19. The method of claim 14 wherein said lottery software is operable for managing lottery game offerings and wherein said interface is a game selection interface.

20. The method of claim 19 wherein said lottery game controller hosts a plurality of available lottery games and wherein said interface allows selection of a game offering hosted by said game controller and selected by a user of said POS terminal, said selection being communicated to said lottery game controller.

21. The method of claim 20 wherein said interface displays an interface associated with said selected game upon said selection being communicated to said game controller.

22. The method of claim 14 wherein said lottery software is operable for managing lottery transactions and wherein said displayed interface is taken from the group consisting of: lottery ticket purchase, lottery ticket cancellation, lottery ticket validation, lottery game result query.

23. The method of claim 22 wherein said lottery transaction controller facilitates processing of lottery transactions with a remote lottery host system.

24. The method of claim 22 wherein said display is a lottery ticket purchase display and wherein said display includes selection options for executing one of: a quick pick ticket, a draw ticket.

25. The method of claim 14 wherein said terminal further is in operating communication with a printing device.

26. The method of claim 14 wherein said interface is displayed via a web browser.

27. A system for processing lottery transactions, comprising:
a POS terminal having a CPU and a display;
a retailer controller, a lottery game controller, and a lottery transaction controller, all in communication with said terminal, said retailer controller including function determination means for determining whether a retailer function input via said POS device is lottery-related or non-lottery related;
retailer software operable by said CPU for displaying an interface associated with at least one non-lottery-related retailer function on said terminal display; and
lottery software operable by said CPU for displaying an interface associated with at least one lottery-related retailer function on said terminal display, whereby, upon receipt via said POS device of an input corresponding to a retailer function, said CPU transmits said input to said retailer controller and upon said input corresponding to a lottery-related function, said retailer controller transmits said input to one of: said lottery game controller or said lottery transaction controller.

28. A method of adapting a point-of-sale device to incorporate lottery transaction capabilities, said POS device having a CPU and a display, comprising the steps of:
providing lottery software operable by said CPU for displaying an interface associated with at least one lottery-related retailer function on said terminal display;
providing a lottery game controller operatively connected to said at least one POS device for providing at least one lottery game option selectable by an interface displayed using said lottery software; and
providing a lottery transaction server operatively connected to said at least one POS device for providing at least one lottery transaction option selectable by an interface displayed using said lottery software.

29. A method for facilitating lottery and non-lottery transactions, comprising the steps of:
providing a point-of-sale device with a plurality of display interfaces, including at least one non-lottery transaction interface, and at least one lottery transaction interface;
providing means for selecting one or more lottery applications for display on said lottery interface;
providing means for communicating said lottery application selection to a central lottery server;
providing means for conducting lottery transactions via said device, including receiving lottery transaction requests, entering said request into said POS device, and communicating said transaction to a lottery transaction server; and
providing means for conducting non-lottery transactions via said device.

30. A lottery system, comprising:
a lottery server operable to process lottery transactions and provide interactive lottery games over a network; and
a plurality of distributor server systems, each having at least one browser-based point-of-sale device for processing lottery and non-lottery transactions, said distributor server systems being in operable communication with said network.

31. A lottery system, comprising:
a lottery server operable to process lottery transactions and provide interactive lottery games over a network;
at least one first distributor server system having at least one browser-based point-of-sale device for processing lottery and non-lottery transactions, said first distributor server system being in operable communication with said network; and
at least one second distributor server system having at least one self-service, browser-based point-of-sale device for processing lottery and non-lottery transactions, said second distributor server system being in operable communication with said network.
